(19) United States
(12) Patent Application Publication
(10) Pub. No.: US 2023/0089904 A1
(43) Pub. Date: Mar. 23, 2023

(54) NON-LINEAR SUBJECT BEHAVIOR PREDICTION SYSTEMS AND METHODS

(71) Applicant: THE BANK OF NEW YORK MELLON, New York, NY (US)

(72) Inventors: Abhinav PRASAD, New York, NY (US); Carlos DE OLIVEIRA, New York, NY (US); Ali MOTAMEDI, New York, NY (US)

(21) Appl. No.: 17/478,359

(22) Filed: Sep. 17, 2021

(51) Int. Cl. G06Q 30/02; G06N 7/00

(52) U.S. Cl. CPC G06Q 30/0201; G06N 7/005

(57) ABSTRACT

The present disclosure relates to predicting non-linear subject behavior that occurs in response to stimulus content. Determining a behavior model for the subject is described. The behavior model describes a density of an observed behavior of a subject. A prior probability subject behavior distribution associated with the observed behavior is determined. The prior probability subject behavior distribution comprises an assumption describing the observed behavior. The prior probability subject behavior distribution comprises a Gamma prior probability distribution. The non-linear subject behavior is predicted based on the stimulus content, the Gamma prior probability distribution, and the behavior model.

### BACKGROUND OF THE INVENTION

### 1. Field of the Invention

The present disclosure relates to systems and methods for predicting non-linear subject behavior.

### 2. Description of Related Art

Non-linear behavior prediction is known. However, typical systems assume a normal prior behavior probability distribution (e.g., a Bayesian prior) for a behavior of interest. Estimating a Bayesian prior has remained a topic of interest and has not yet been solved satisfactorily for non-linear behavior prediction purposes. These priors can be default priors from statistical software, for example, or they can be user-specified based on previous knowledge (e.g., based on a guess, data analysis, expert opinion, visual analysis etc.).

### SUMMARY OF EMBODIMENTS OF THE INVENTION

The following is a non-exhaustive listing of some aspects of the present techniques. These and other aspects are described in the following disclosure.

One aspect of the present disclosure relates to a non-transitory computer readable medium having instructions thereon. The instructions, when executed by a computer, cause the computer to predict non-linear subject behavior that occurs in response to stimulus content. The instructions cause operations comprising determining a behavior model for the subject. The behavior model describes a density of an observed behavior of a subject. The instructions cause operations comprising determining a prior probability subject behavior distribution associated with the observed behavior. The prior probability subject behavior distribution comprises an assumption describing the observed behavior. The prior probability subject behavior distribution comprises a Gamma prior probability distribution. The instructions cause operations comprising receiving the stimulus content. The instructions cause operations comprising predicting, based on the stimulus content, the Gamma prior probability distribution, and the behavior model, the non-linear subject behavior.

In some embodiments, the operations further comprise determining parameters of the Gamma prior probability distribution by minimizing a Kullback-Leibler (KL) divergence between the Gamma prior probability distribution over a specific period or range versus a generic Gamma distribution.

In some embodiments, the parameters of the Gamma prior probability distribution comprise a shape (α) and a rate (β).

In some embodiments, the predicting comprises Bayesian inferencing based on the behavior model and the Gamma prior probability distribution.

In some embodiments, the behavior model is a Markov Chain Monte Carlo based mixture model.

In some embodiments, the density of observed behavior comprises a quantity and/or amount of repeated statistically significant behavior over time.

In some embodiments, the density of observed behavior is determined with a mixture model derived from a Dirichlet process.

In some embodiments, the behavior model is trained by comparing one or more different model outputs, generated based on known inputs, to corresponding target outputs for the known inputs, and adjusting a parameterization of the behavior model to reduce or minimize a difference between an output and a target output, for a corresponding input.

In some embodiments, the Gamma prior probability distribution can be configured to approximate multiple distribution shapes, and wherein the Gamma prior probability distribution is determined by minimizing a Kullback-Leibler (KL) divergence between the Gamma prior probability distribution over a specific period or range versus a generic Gamma distribution.

In some embodiments, the behavior model is a Markov Chain Monte Carlo (MCMC) based mixture model. The Gamma prior probability distribution is applied as a prior in the MCMC based mixture model.

In some embodiments, the operations further comprise sampling a posterior predictive from the behavior model using a Metropolis Hastings technique.

In some embodiments, the behavior model is a rate sensitivity behavior model. The rate sensitivity behavior model describes a customer bank account balance as a banking interest rate provided to a customer changes over time. The prior probability subject behavior distribution comprises an assumption describing customer sensitivity to the banking interest rate. Predicting the non-linear subject behavior comprises predicting non-linear customer sensitivity to the banking interest rate provided to the customer, based on the Gamma prior probability distribution and the rate sensitivity behavior model. In some embodiments, the operations further comprise determining a banking interest rate provided to the customer based on the non-linear customer sensitivity.

In some embodiments, the prior probability distribution comprises an exponential distribution.

In some embodiments, the subject is a human, and the observed behavior comprises customer sensitivity to banking interest rate changes; customer sensitivity to provider customer service, cost, and/or quality; a customer response to advertising, media content, and/or streaming content; or a drug and/or dosage sensitivity. In some embodiments, the subject is a wireless device, and the observed behavior comprises sensitivity to noise or alternate communication frequencies. In some embodiments, the subject is a vehicle, and the observed behavior comprises sensitivity to human driver actions and/or physical driving environment parameters. In some embodiments, the subject is a machine, and the observed behavior comprises location detection, temperature determination, or quality determination.

Another aspect of the present disclosure relates to a method for predicting non-linear subject behavior that occurs in response to stimulus content. The method comprises determining a behavior model for the subject. The behavior model describes a density of an observed behavior of a subject. The method comprises determining a prior probability subject behavior distribution associated with the observed behavior. The prior probability subject behavior distribution comprises an assumption describing the observed behavior. The prior probability subject behavior distribution comprises a Gamma prior probability distribution. The method comprises receiving the stimulus content. The method comprises predicting, based on the stimulus content, the Gamma prior probability distribution, and the behavior model, the non-linear subject behavior.

Another aspect of the present disclosure relates to a system for predicting non-linear subject behavior that occurs in response to stimulus content. The system comprises one or more processors configured by machine readable instructions to perform operations. The operations comprise determining a behavior model for the subject. The behavior model describes a density of an observed behavior of a subject. The operations comprise determining a prior probability subject behavior distribution associated with the observed behavior. The prior probability subject behavior distribution comprising an assumption describing the observed behavior. The prior probability subject behavior distribution comprising a Gamma prior probability distribution. The operations comprise receiving the stimulus content. The operations comprise predicting, based on the Gamma prior probability distribution and the behavior model, the non-linear subject behavior.

Another aspect of the present disclosure relates to a non-transitory computer readable medium having instructions thereon. The instructions, when executed by a computer, cause the computer to predict non-linear subject behavior in response to stimulus content. The predicting is based on a Gamma prior probability behavior distribution instead of a normal prior probability behavior distribution. The predicting is configured to enhance a determination of future content stimuli compared to content stimuli that would otherwise have been determined for a subject. The instructions cause operations comprising: determining a behavior model for the subject, wherein: the behavior model describes a density of an observed behavior of the subject, the behavior model is a Markov Chain Monte Carlo based mixture model, and the density is determined with a mixture model derived from a Dirichlet process; determining a prior probability subject behavior distribution associated with the observed behavior, wherein: the prior probability subject behavior distribution comprises a Gamma prior probability distribution, parameters of the Gamma prior probability distribution comprise a shape (α) and a rate (β), and parameters of the Gamma prior probability distribution are determined by minimizing a Kullback-Leibler (KL) divergence between the Gamma prior probability distribution over a specific period or range versus a generic Gamma distribution; receiving the stimulus content; receiving the stimulus content; and predicting, based on the stimulus content, the Gamma prior probability behavior distribution, and the behavior model, the non-linear subject behavior; and determining the future content stimuli based on the non-linear subject behavior.

These and other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 illustrates a non-linear subject behavior prediction system, in accordance with one or more embodiments.

FIG. 2 illustrates a cash deposit account balance for a given customer (subject) as a banking interest rate changes over time, in accordance with one or more embodiments.

FIG. 3 illustrates how a Gamma prior probability distribution can be used to approximate a prior behavior such as one month US treasury yields for time periods since 2010, since 2012, and since 2015, in accordance with one or more embodiments.

FIG. 4 illustrates how the present system improves the accuracy of non-linear subject behavior predictions relative to prior systems, in accordance with one or more embodiments.

FIG. 5 illustrates how several Gamma prior probability distributions can potentially be used to accurately predict non-linear subject behavior, in accordance with one or more embodiments.

FIG. 6 provides two additional illustrations of how Gamma prior probability distributions can be used to accurately predict non-linear subject behavior, in accordance with one or more embodiments.

FIG. 7 is a diagram that illustrates an exemplary computing system in accordance with one or more embodiments.

FIG. 8 illustrates a method for predicting non-linear subject behavior with a prediction system, in accordance with one or more embodiments.

### DETAILED DESCRIPTION OF EXEMPLARY EMBODIMENTS OF THE INVENTION

Businesses and other entities try to determine, infer, and/or otherwise predict non-linear behavioral responses to variable content stimuli. These predictions are often used to build projections and estimates for business goals, and/or other purposes. Generally, non-linear behavior includes behavior that does not increase, decrease, and/or otherwise change in a linear fashion relative to changes in given stimulus content. Non-linear subject behavior may include, for example, instances where the subject is a human, and the non-linear behavior comprises customer sensitivity to banking interest rate changes; customer sensitivity to provider customer service, cost, and/or quality; a customer response to advertising, media content, and/or streaming content; a drug and/or dosage sensitivity; and/or other non-linear behavior. Non-linear subject behavior may include instances where the subject is a wireless device, and the non-linear behavior comprises sensitivity to noise or alternate communication frequencies, for example. Non-linear subject behavior may include instances where the subject is a vehicle, and the non-linear behavior comprises sensitivity to human driver actions and/or physical driving environment parameters, for example. Non-linear subject behavior may include instances where the subject is a machine, and the non-linear behavior comprises location detection, temperature determination, quality determination, etc., for example. Other examples are contemplated.

Non-linear behavior predictions are typically based on estimations of prior behavior (e.g., if a subject has behaved a certain way in the past, they are likely to behave that way in the future). As described above, estimating a prior behavior distribution (e.g., a Bayesian prior) has remained a problem for non-linear behavior prediction purposes. Typical non-linear behavior prediction systems assume the probability of a prior behavior follows a normal prior behavior distribution (e.g., a normal Bayesian prior) for a behavior of interest – e.g., a large amount of similar or the same behavior around some sort of average, with the probability of other behavior decreasing to zero as the other behavior varies more and more relative to the average behavior. However, a normal distribution is often not representative of actual subject behavior, and generally cannot be flexibly adapted to varying subject behavior distributions. Accordingly, there is an unmet need for an enhanced (relative to prior systems) non-linear subject behavior prediction system.

In contrast to the normal probability distribution used by prior systems to represent prior subject behavior, a Gamma distribution can be used to represent prior subject behavior more accurately (relative to subject behavior represented with a normal or other distribution). The Gamma distribution can be flexibly adapted to varying subject behavior distributions. The Gamma distribution provides a more dynamic representation of the probability of prior subject behavior that can be used for different applications (see discussion above), where subject behavior may change over time. In addition, a Gamma distribution can be defined using two parameters (e.g., shape and rate as described below), and does not require thousands of data points to define the distribution (as is necessary with other distributions).

Advantageously, the present systems and methods improve predictions of non-linear subject behavior relative to prior systems. The present systems and methods are configured improve predictions of non-linear subject behavior by determining a behavior model for a subject. A prior probability subject behavior distribution associated with the observed behavior is also determined. The prior probability subject behavior distribution comprises a Gamma prior probability distribution. Non-linear subject behavior is predicted based on the Gamma prior probability distribution and the behavior model.

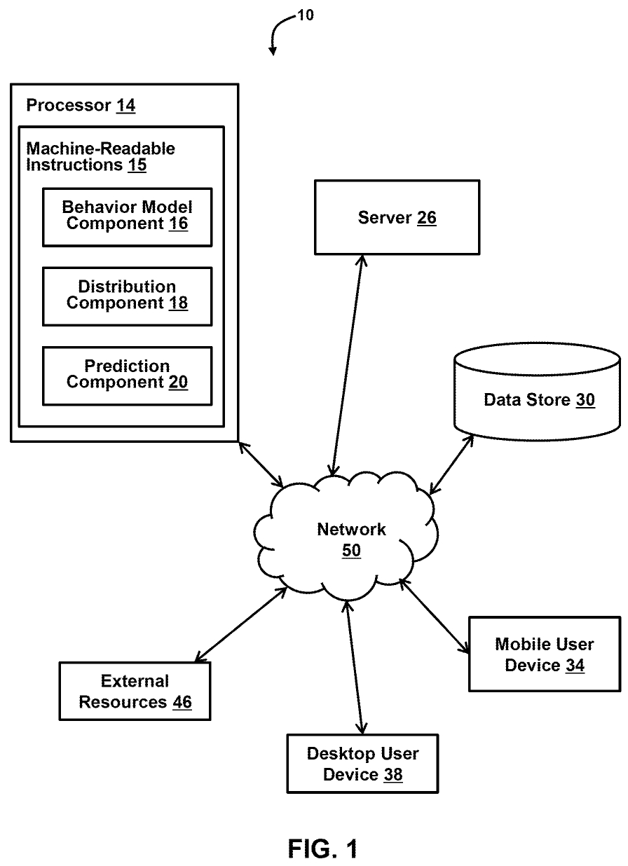

FIG. 1 illustrates a non-linear behavior prediction system 10. In some embodiments, system 10 comprises a processor 14, a server 26, a data store 30, a mobile user device 34, a desktop user device 38, external resources 46, a network 50, and/or other components. Each of these components is described, in turn, below.

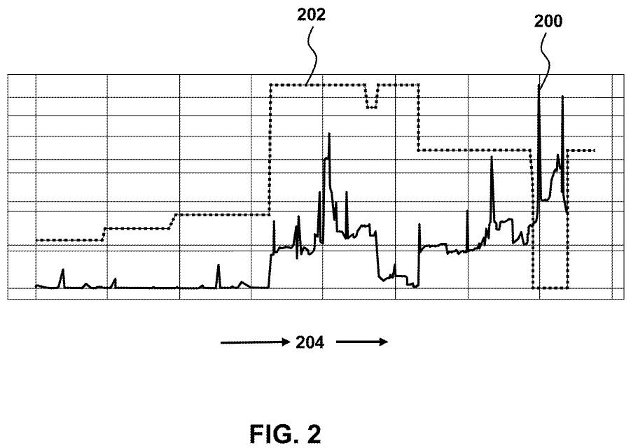

By way of one non-limiting introductory example, system 10 is better able to predict a customer’s sensitivity (e.g., non-linear behavior comprising depositing and withdrawing money from a bank account) to cash deposit banking interest rate changes compared to prior systems. FIG. 2 illustrates a cash deposit account balance 200 for a given customer as a banking interest rate 202 changes over time 204. Customer cash deposit rate sensitivity is an important parameter that banks use to classify accounts, measure attrition, and/or set interest rates for cash deposits. Banks set interest rates such as rate 202 based in part on customer sensitivity to (e.g., deposits and/or withdrawals caused by) interest rate changes. However, not every deposit or withdrawal that changes balance 200 can be attributed to changes in rate 202. In this example, system 10 (FIG. 1) is configured to better predict changes in balance 200 (e.g., non-linear behavior) that would actually be caused by changes in rate 202 (e.g., for given stimulus content).

Returning to FIG. 1, these and other benefits of system 10 are described in greater detail below, along with describing the components of system 10 and their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

Processor 14 is configured to provide information-processing capabilities in matching system 10. As such, processor 14 may comprise one or more of a digital processor, an analog processor, a digital circuit designed to process information, an analog circuit designed to process information, a state machine, and/or other mechanisms for electronically processing information. Although processor 14 is shown in FIG. 1 as a single entity, this is for illustrative purposes only. In some embodiments, processor 14 may comprise a plurality of processing units. These processing units may be physically located within the same device (e.g., server 26, mobile user device 34, desktop user device 38, etc.), or processor 14 may represent processing functionality of a plurality of devices operating in coordination. In some embodiments, processor 14 may be and/or be included in a computing device such as a desktop computer, a laptop computer, a smartphone, a tablet computer, a server, and/or other computing devices. Such computing devices may run one or more electronic applications having graphical user interfaces configured to facilitate user interaction with system 10.

As shown in FIG. 1, processor 14 is configured by machine readable instructions 15 to execute one or more computer program components. The computer program components may comprise software programs and/or algorithms coded and/or otherwise defined by machine readable instructions 15 and/or embedded in processor 14, for example. The one or more computer program components may comprise one or more of a behavior mode. component 16, a distribution component 18, a prediction component 20, and/or other components. Processor 14 may be configured to execute components 16, 18, 20, and/or other components by software; hardware; firmware; some combination of software, hardware, and/or firmware; and/or other mechanisms for configuring processing capabilities on processor 14.

It should be appreciated that although components 16, 18, and 20 are illustrated in FIG. 1 as being co-located in processor 14, one or more of the components 16, 18, or 20 may be located remotely from the other components. The description of the functionality provided by the different components 16, 18, 20, and/or 22 described below is for illustrative purposes, and is not intended to be limiting, as any of the components 16, 18, and/or 20 may provide more or less functionality than is described, which is not to imply that other descriptions are limiting. For example, one or more of the components 16, 18, and/or 20 may be eliminated, and some or all of its functionality may be provided by others of the components 16, 18, and/or 20, again which is not to imply that other descriptions are limiting. As another example, processor 14 may include one or more additional components that may perform some or all of the functionality attributed below to one of the components 16, 18, and/or 20.

Behavior model component 16 is configured to determine a behavior model for a subject. The behavior model describes (models) a density of an observed behavior of a subject. An observed behavior may include a consistent and/or statistically significant action and/or series of actions (such as regular deposits and/or regular withdrawals in the banking example described above), and/or changes in the action and/or series of actions (such as a repeated and discernable change in deposits and/or withdrawals) made in response to given stimulus content (such as a certain interest rate, or changes in interest rate, and/or other market indices/factors in this example). Behavior does not include random and/or one time actions, or actions that are not performed in response to stimulus content of interest. For clarity, stimulus content may be any data, information, event, action, occurrence, situation, or any other factor that causes a subject to behave a certain way (e.g., a certain interest rate provided to a banking customer, a change in that interest rate, etc.).

The density of observed behavior comprises a quantity and/or amount of the repeated statistically significant behavior over time. The observed behavior is something that is repetitive and hence well represented by density. In some embodiments, the density comprises a frequency of the observed behavior. If a quantity, amount, and/or frequency of a behavior increases or decreases over time, the density of that behavior changes. Returning to the banking example described above, the density of observed behavior may comprise the number of withdrawals or deposits made by a subject over time. This density may change with changing interest rates for example. Density based regression using normal mixture to approximate components is statistically robust. In some embodiments, the density of observed behavior is determined with and/or based on a mixture model derived from a Dirichlet process. Generally speaking, as known in the art, in probability theory the Dirichlet processes are a family of stochastic processes whose realizations are probability distributions. In other words, a Dirichlet process is a probability distribution whose range is itself a set of probability distributions. It is often used to describe the prior knowledge about the distribution of random variables—how likely it is that the random variables are distributed according to one or another particular distribution. The mixture model contemplated herein may be Markov Chain Monte Carlo (MCMC) based, as described below.

In some embodiments, the behavior model may comprise one or more algorithms. The one or more algorithms may be and/or include mathematical equations, plots, charts, and/or other tools and model components. For example, in some embodiments, the present systems and methods include (or use) an empirical simulation model that comprises one or more multi-dimensional algorithms. The one or more multi-dimensional algorithms comprise one or more non-linear, linear, or quadratic functions representative of the behavior of a subject. The behavior model may predict outputs based on correlations between various inputs (e.g., prior behavior probability distributions, specific stimulus content, etc.). The behavior model is trained by comparing one or more different model outputs, generated based on known inputs, to corresponding target outputs for the known inputs, and adjusting a parameterization of the behavior model to reduce or minimize a difference between an output and a target output, for a corresponding input.

In some embodiments, the Bayesian MCMC technique described herein can include a neural model in addition to and/or instead of the one or more algorithms described above. Since MCMC is a generative model, the generated samples can be used to train a deep neural network to increase its performance, especially when data is scarce or imbalanced. For example, in some embodiments, the behavior model may be a machine learning model and/or any other parameterized model. In some embodiments, the machine learning model (for example) may be and/or include mathematical equations, algorithms, plots, charts, networks (e.g., neural networks), and/or other tools and machine learning model components. For example, the machine learning model may be and/or include one or more neural networks having an input layer, an output layer, and one or more intermediate or hidden layers. In some embodiments, the one or more neural networks may be and/or include deep neural networks (e.g., neural networks that have one or more intermediate or hidden layers between the input and output layers).

As an example, the one or more neural networks may be based on a large collection of neural units (or artificial neurons). The one or more neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function that combines the values of all its inputs together. In some embodiments, each connection (or the neural unit itself) may have a threshold function such that a signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, the one or more neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for the one or more neural networks may be freer flowing, with connections interacting in a more chaotic and complex fashion. In some embodiments, the intermediate layers of the one or more neural networks include one or more convolutional layers, one or more recurrent layers, and/or other layers.

The one or more neural networks may be trained (i.e., whose parameters are determined) using a set of training information. The training information may include a set of training samples. Each sample may be a pair comprising an input object (typically a vector, which may be called a feature vector) and a desired output value (also called the supervisory signal). A training algorithm analyzes the training information and adjusts the behavior of the neural network by adjusting the parameters (e.g., weights of one or more layers) of the neural network based on the training information. For example, given a set of N training samples of the form {(x₁,y₁ ),(x₂,y₂),... ,(x_{N},y_{N} )} such that xᵢ is the feature vector of the i-th example and _{yi} is its supervisory signal, a training algorithm seeks a neural network g:X→Y, where X is the input space and Y is the output space. A feature vector is an n-dimensional vector of numerical features that represent some object (e.g., a simulated aerial image, a wafer design, a clip, etc.). The vector space associated with these vectors is often called the feature space. After training, the neural network may be used for making predictions using new samples.

In some embodiments, the behavior model is a Markov Chain Monte Carlo (MCMC) based mixture model. MCMC is a Bayesian inference technique that combines a Monte Carlo integral with a Markov chain generated from sampling. The Monte Carlo integral is a known technique that solves following integral:

$${\text{E}}_{π} \left[h \left(x\right)\right] = \int h \left(x\right) π \left(x\right) d x$$

Since the integral is difficult to solve, π (x) can be approximated by samples x₁, x₂, ..., xₙ and

$${\text{E}}_{π} \left[h \left(x\right)\right] = \frac{1}{N} {\sum }_{t = 1}^{n} h \left({x}_{t}\right)$$

The Markov Chain is generated by sampling with a conditional probability relationship. For example,

$${\text{X}}_{\text{t} + 1} ∼ \text{p} \left({\text{x}}_{1} \vert {\text{x}}_{\text{t}}\right)$$

where t = 1, 2, ..., n, with an assumption that Xₜ₊ᵢ only depends on xₜ. Hence

$$\text{p} \left({\text{x}}_{\text{t} + 1} \vert {\text{x}}_{\text{t}}\right) = \text{p} \left({\text{x}}_{\text{t+1}} \vert {\text{x}}_{\text{t}} {\text{,x}}_{\text{t-1,} …} {\text{x}}_{1}\right)$$

as the limit as t goes to infinity (Markov Chain converges to a stationary distribution). Constructing a Markov Chain whose stationary distribution is a target distribution was first shown by Metropolis and improved by Hastings, which was called MH or Metropolis Hastings. By extension of Bayes’ rule, a posterior (a prediction) generated by the model is proportional to a likelihood of a result multiplied by a prior (e.g., the Gamma prior behavior probability distribution in system 10).

In some embodiments, behavior (e.g., rate sensitivity behavior in the banking example above) can be defined as a change in some indicator of the behavior (e.g., bank account balance) with respect to some measure of stimulus content (e.g., interest rate in this example). Instantaneous behavior can be represented by dy/dx, where y = the indicator of the behavior (e.g., bank account balance) and x = the measure of the stimulus content (e.g., interest rate). The behavior (e.g., rate sensitivity behavior) is represented by a slope, m, (or rate of change) associated with this relationship (y = mx + c), where c is a constant.

In some embodiments, determining the behavior model comprises performing a linear regression on prior behavior data, which is improved with the Mixture of Models technique, with a density estimation using a Markov Chain Monte Carlo model. In some embodiments, keeping with the banking example, a normal mixture is modeled with µ and actual observations for bank account balance Bᵢ (an example of prior behavior data) and interest rate x. In some embodiments, determining the behavior model comprises performing MCMC and sampling a posterior predictive from the behavior model using the Metropolis Hastings technique. A normal mixture is a mixture of several normal/gaussian distributions. A normal mixture essentially approximates a distribution by many small normal distributions.

As an example, Bᵢ ~ N(µᵢ, σ); µ | x ~ γᵢ + δᵢ xᵢ, where γᵢ ~ N(a1,b1), δᵢ ~ N(a2,b2), and τᵢ ~ gamma(α, β) (the Gamma distribution); such that: Posterior [symbol] Likelihood × Prior i.e.

$$\text{P} \left({μ}_{\text{j} ,} σ \vert x\right) ∝ \text{P} \left(x \vert {μ}_{\text{i}} , σ\right) * {τ}_{i}$$

where P indicates probability (e.g., the probability of a predicted posterior (a predicted subject behavior) is proportional to a likelihood of that behavior multiplied by the Gamma prior probability distribution - τᵢ); where N represents a normal distribution; where µ represents a mean of a balance B; where σ represents a std deviation of balance B; where δᵢ represents a distribution multiplier by which xᵢ can vary; and where γᵢ represents a constant distribution by which xᵢ is affected. This is a linear relation (instantaneous) between xᵢ and y such as y = mxᵢ + c, where variables and constants are distributions. The relationship between x and y is still non-linear in this example. This linear equation can be non-linear also, such as represented by a neural net. ]. In some embodiments, parameters of the Gamma prior probability distribution comprise a shape (α) and a rate (β). Specifically, the gamma prior probability distribution can be parameterized in terms of a shape parameter α = k and an inverse scale parameter β = ⅟θ, called a rate parameter. A random variable X that is gamma-distributed with shape α and rate β is denoted

$$X ∼ Γ \left(α , β\right) ≡ \text{Gamma} \left(α , β\right) .$$

Distribution component 18 is configured to determine a prior probability subject behavior distribution associated with the observed behavior. The prior probability subject behavior distribution comprises an assumption describing the observed behavior. The assumption comprises a guess or an estimation describing prior subject behavior. The guess or estimation is associated with behavior over a certain (usually recent) time period. The time period may comprise minutes, hours, days, weeks, months, and/or years depending on the application (e.g., predicting customer sensitivity to banking interest rate changes; customer sensitivity to provider customer service, cost, and/or quality; a customer response to advertising, media content, and/or streaming content; a drug and/or dosage sensitivity; wireless device sensitivity to noise or alternate communication frequencies; self-driving vehicle sensitivity to human driver actions and/or physical driving environment parameters; machine location detection, temperature determination, quality determination; etc.) for which system 10 is being used. Here, that guess or estimation is concerned with the distribution of that prior subject behavior. In Bayesian statistical inference, a prior probability distribution (e.g., “the prior”) of an uncertain quantity is the probability distribution that would express a belief or expectation (e.g., an assumption) about this quantity before some evidence is taken into account. For example, a prior could be a probability distribution representing the relative behavior of customers who are offered different banking interest rates over time.

Discrete distribution functions that could potentially be used as a prior include (with conjugate) the Normal distribution [N(µᵢ, σ)] (as described above), the Beta and Dirichlet Distribution [B(α , β) = Γ(α) Γ(β) / Γ(α + β] where Γ represents the Gamma distribution [τᵢ ~ gamma(α, β)] (as described above), the Beta Binomial distribution, and/or other distributions. In system 10, the prior probability subject behavior distribution comprises a Gamma prior probability distribution. Advantageously, compared to other possible distributions, the Gamma prior probability distribution can be configured to approximate multiple distribution shapes. In some embodiments, the prior probability distribution comprises an exponential distribution shape, a binomial distribution shape, and/or a one tailed distribution, each of which can be approximated by the Gamma prior probability distribution.

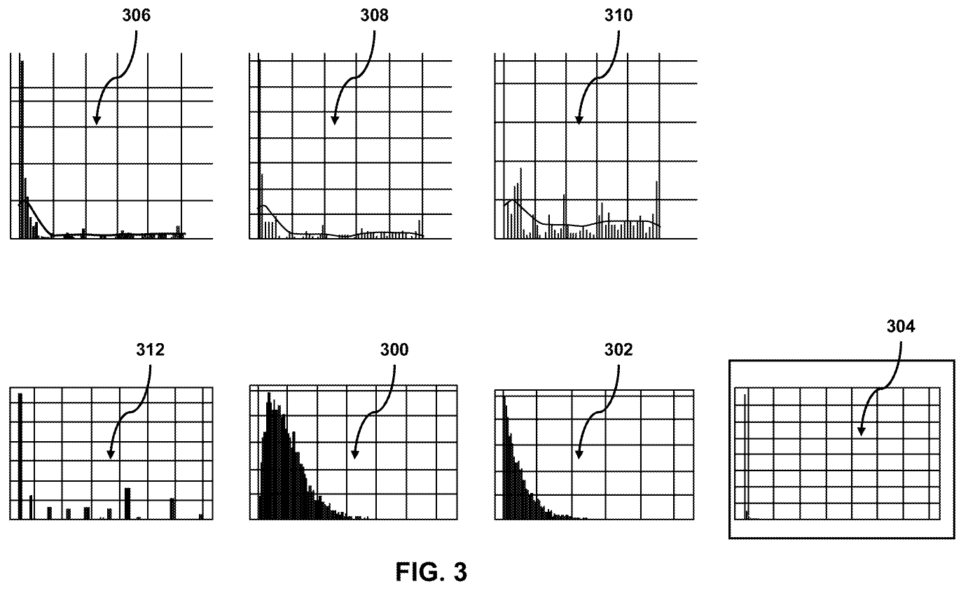

For example, FIG. 3 illustrates how a Gamma prior probability distribution 300, 302, 304 can be used to approximate a prior behavior such as one month US treasury yields 306, 308, 310 for time periods since 2010, since 2012, and since 2015 (graph 312 illustrates a combination of yields 306, 308, and 310). In this example, Gamma prior probability distributions 300, 302, and 304 have shape α and rate β parameters of (2, 2), (1,1), and (0.1, 0.7), respectively. As shown in FIG. 3, Gamma prior probability distribution 304, with shape and rate parameters of 0.1 and 0.7, are best suited to approximate the one month US treasury yields 306, 308, and 310 for time periods since 2010.

The Gamma distribution has two parameters, α and β, or shape and rate (as described above), such that τᵢ ~ gamma(α, β). In some embodiments, parameters of the Gamma prior probability distribution are determined by minimizing a Kullback-Leibler (KL) divergence between the Gamma prior probability distribution over a specific period or range versus a generic Gamma distribution. The Kullback-Leibler divergence is a measure of how one probability distribution is different from a second, reference probability distribution. The KL Divergence is a well understood method of comparing distributions and it is used here as part of our search for α and β that best fits a distribution of a time varying quantity, such as rate.

For example, a Gamma distribution that best approximates a prior behavior probability distribution over time period T is determined by minimizing a KL-divergence between a generated distribution τᵢ for a given shape / rate pair (α, β) and the actual distribution of the prior behavior. Distribution component 18 may be configured to execute one or more algorithms for estimating a prior Gamma distribution. For example, distribution component 18 may be configured to read, receive, or otherwise determine a prior behavior distribution over a time T. This may include initializing (α, β) from a mean and standard deviation (std) of an observed distribution of prior behavior data, where the mean = α β, std = β √α. This may include an initializing step _ α , step _ β (step size for fast or slow convergence), with a linear or non-linear factor = k. For i = 1..N (pair of α ,β) in both directions starting from initialization. Two possible example methods include:
Method 1:
   generate Gamma distribution τᵢ for α ,β as initialized + step_α* k, step_β* k
   generate Gamma distribution τᵢ for α ,β as initialized - step_α* k, step_β* k
   minimize KL-divergence between τᵢ and T in each direction and keep track of both directions
   compare skewness, kurtosis as additional metric with shape
   increment or decrement step_α, step_β for faster or slower convergence (linear or non-linear rate)
   Select the τᵢ that minimized the KL-divergence.
Method 2:
   generate Gamma distribution τᵢ for α, β as initialized + step_α* k, step_β* k
   generate Gamma distribution τᵢ for α, β as initialized - step_α* k, step_β* k
   minimize KL-divergence between τᵢ and T in each direction and keep track of both directions
   increment or decrement step_α, step_β for faster or slower convergence (linear or non-linear rate)
   Select top K τᵢ that minimized the KL-divergence
   Generate MSE (Mean square error) with this model and test samples taken from top N (for e.g. N=2) bins for the x parameter (rate in our example)
   Select the α, β for τᵢ with min MSE.
In some embodiments, as described above, the behavior model is a Markov Chain Monte Carlo (MCMC) based mixture model. The Gamma prior probability distribution that minimized the KL-divergence (e.g., the τᵢ) is applied as a prior in the MCMC based mixture model. In some embodiments, distribution component 18 is configured to estimate a slope of sensitivity between any two given rates by drawing from a posterior predictive and generating an angular measure of sensitivity to be used upstream.

Prediction component 20 is configured to predict, infer, and/or otherwise determine the non-linear subject behavior. The non-linear subject behavior is predicted based on input stimulus content, the Gamma prior probability distribution, the behavior model, and/or other information. In some embodiments, prediction component 20 is configured to predict a probability (e.g., the probability of a predicted posterior) of a non-linear subject behavior based on its proportionality (e.g., as described above) to a likelihood of that behavior multiplied by the Gamma prior probability distribution - τᵢ. For example, prediction component 20 may be configured to receive information indicative of certain stimulus content (e.g., a specific interest rate), and use the behavior model and Gamma prior probability distribution (as described above) to predict a customer’s behavior (e.g., reaction, sensitivity - deposit and/or withdrawal behavior in this example) in response to that stimulus content.

In some embodiments, the predicting comprises Bayesian inferencing based on the behavior model and the Gamma prior probability distribution. Bayesian inferencing is a method of statistical inference in which Bayes’ theorem is used to update the probability for a hypothesis as more evidence or information becomes available. In the banking example, as time progresses and more information is learned about a customer’s response to changing interest rates, that additional information may be used to update the behavior model and/or predictions made by prediction component 20.

In some embodiments, by way of a non-limiting example associated with banking as described above, the behavior model may be a rate sensitivity behavior model. The rate sensitivity behavior model describes a customer bank account balance as a banking interest rate provided to a customer changes over time. The prior probability subject behavior distribution comprises an assumption describing customer sensitivity to the banking interest rate (e.g., a Gamma distribution of prior customer behaviors); and predicting the non-linear subject behavior comprises predicting non-linear customer sensitivity to the banking interest rate provided to the customer, based on the Gamma prior probability distribution and the rate sensitivity behavior model.

Continuing with this example, in some embodiments, system 10 may be configured to determine a banking interest rate provided to the customer based on the non-linear customer sensitivity. The banking interest rate is determined such that predicted customer behavior is beneficial for the bank. Instead of setting a blanket rate (a standard rate) across all customers without regard for each individual customer’s sensitivity to the rate, rates can be determined individually for each customer based on a prediction of the customer’s reaction (e.g., sensitivity –non-linear behavior – a number of deposits and/or withdrawals, or bank account balance changes) to the rate. This would allow a bank to set the rate according to the customer’s own individual sensitivity to the rate, so the bank does not pay a higher than needed rate to non-sensitive clients, or a lower than required rate, which could cause the bank to lose a customer.

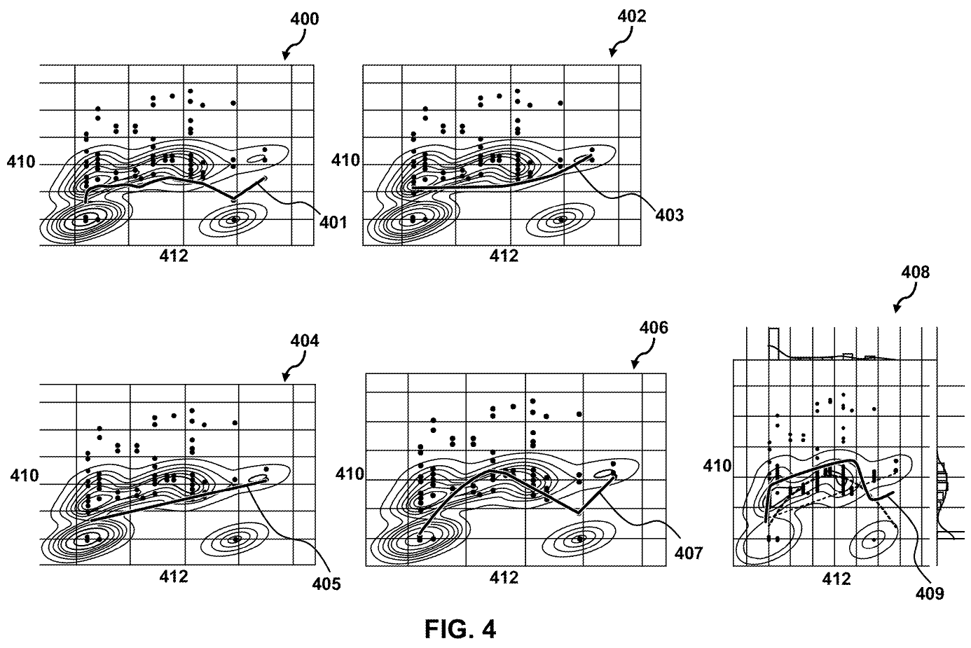

FIG. 4 illustrates how system 10 (FIG. 1) improves the accuracy of non-linear subject behavior predictions relative to prior systems. FIG. 4 illustrates several plots 400, 402, 404, 406, 408 showing non-linear subject behavior 410 versus certain stimulus content 412. In this example, non-linear subject behavior 410 is represented by customer bank account balance, and stimulus content 412 is represented by an interest rate. Plot 408 illustrates predicting (shown by the line 409 drawn through the plotted points) non-linear subject behavior using system 10 as described herein (e.g., Gamma enhanced MCMC). As shown in plot 408, line 409 follows the plotted data much more closely than lines 401 in plot 400 (where Gradient Boosting Machine (GBM) regression was used to predict non-linear subject behavior), 403 in plot 402 (where Support Vector Machine (SVM) poly regression was used), 405 in plot 404 (where linear regression was used), and 407 in plot 405 (where SVM Radial Basis Function (RBF) regression was used).

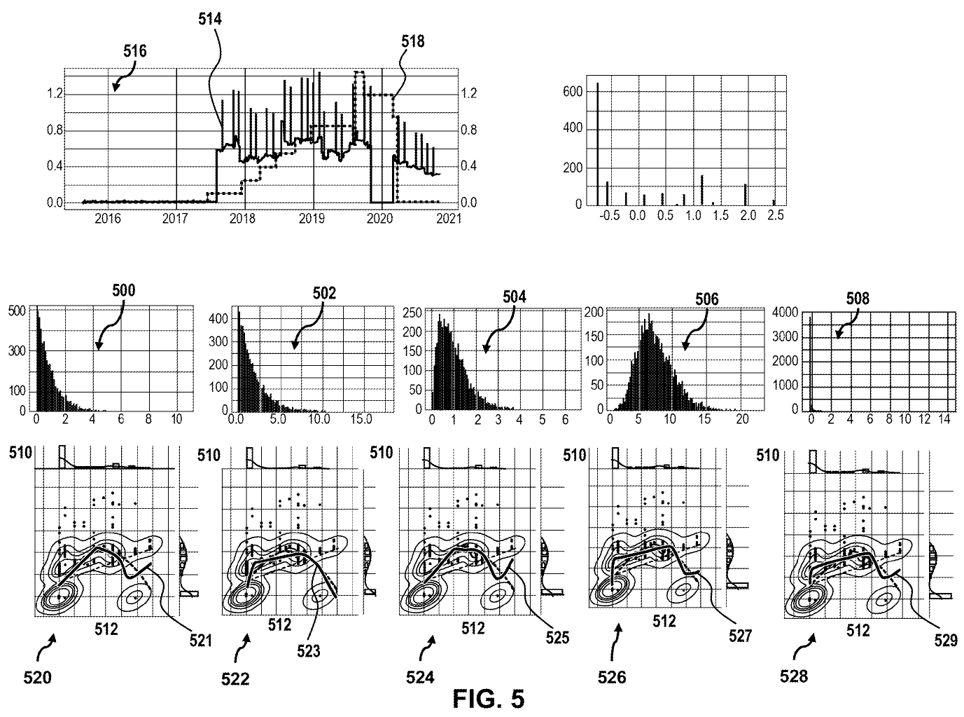

FIG. 5 illustrates how several Gamma prior probability distributions 500 (alpha 1, beta 1), 502 (alpha 1, beta 0.5), 504 (alpha 2, beta 2), 506 (alpha 7.5, beta 1), and 508 (alpha 0.1, beta 0.7) can potentially be used to accurately predict non-linear subject behavior. FIG. 5 also illustrates several corresponding plots 520, 522, 524, 526, 528 showing non-linear subject behavior 510 versus certain stimulus content 512. In this example, non-linear subject behavior 510 is represented by customer bank account balance (also see balance 514 in plot 516), and stimulus content 512 is represented by an interest rate (see rate 518 in plot 516. Plots 520-528 illustrate predicting (shown by the lines 521-529 drawn through the plotted points) non-linear subject behavior using system 10 as described herein (e.g., Gamma enhanced MCMC), with each corresponding Gamma prior probability distribution. As shown in plots 520-528, many of lines 521-529 do a reasonable job of closely following the plotted data, with line 529 (generated based on Gamma prior probability distribution 508) seeming being the best.

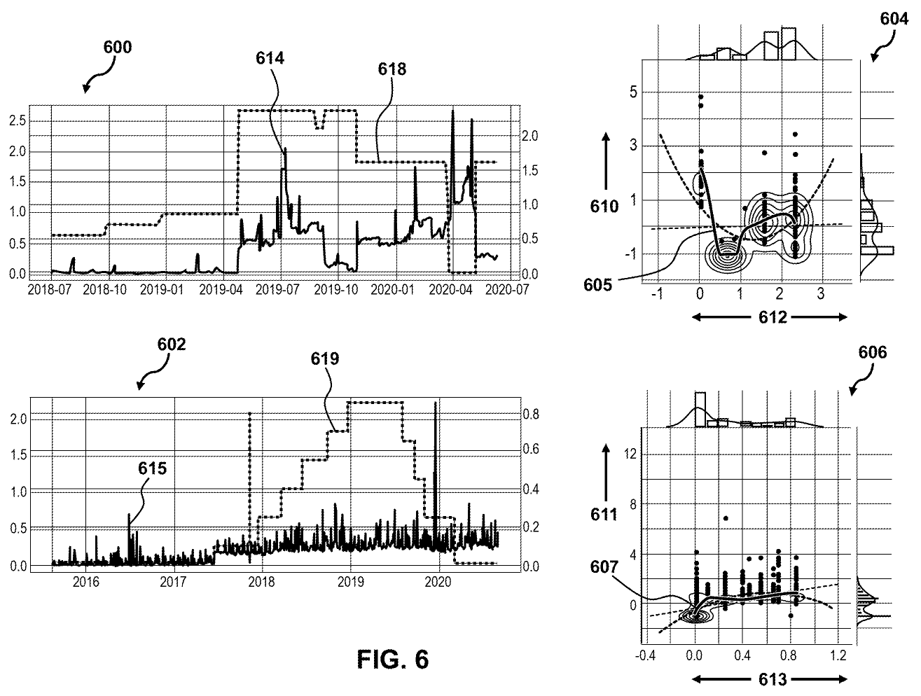

FIG. 6 provides two additional illustrations 600, 602 of how Gamma prior probability distributions can be used to accurately predict non-linear subject behavior. FIG. 6 illustrates plots 604, 606 showing non-linear subject behavior 610, 611 versus certain stimulus content 612, 613. In this example, non-linear subject behavior 610, 611 is represented by different customer bank account balances (also see balances 614 and 615 in illustrations 600, 602), and content stimuli 612 and 613 are represented by different interest rates (see rates 618 and 619 in illustrations 600, 602). Plots 604 and 606 illustrate predicting (shown by the lines 605 and 607 drawn through the plotted points) non-linear subject behavior using system 10 (FIG. 1) as described herein (e.g., Gamma enhanced MCMC), with each corresponding Gamma prior probability distribution. Overall, FIG. 6 shows sensitivity of balance to the rate, which can be flat or highly sensitive to a given value of rate. The distribution of rate over a given time period T (e.g., the last 5 years) is approximated via the Gamma distribution / function which lends well to a property of rate that remains low or close to zero during an economic crisis (for example), longer than when it starts to rise, giving a non-linear dimension to the illustration.

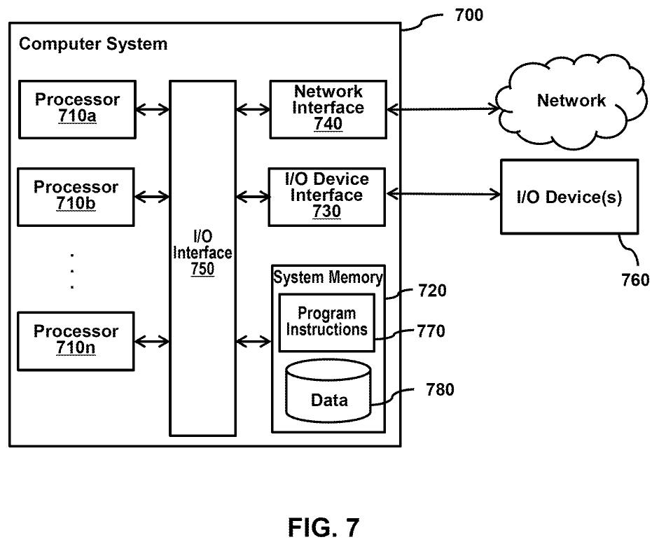

Returning to FIG. 1, in some embodiments, processor 14 is executed by one or more of the computers described below with reference to FIG. 7. The components of system 10, in some embodiments, communicate with one another in order to provide the functionality of processor 14 described herein. In some embodiments, data store 30 may store data about subject behavior, a behavior model, or other information. Server 26 may expedite access to this data by storing likely relevant data in relatively high-speed memory, for example, in random-access memory or a solid-state drive. Server 26 may communicate with webpages and/or other sources of network information. Server 26 may serve data to various applications that process data related to non-linear subject behavior prediction, and/or other data. The operation of server 26 and data store 30 may be coordinated by one or more processors 14 (which may be located within and/or formed by server 26, mobile user device 24, desktop user device 38, external resources 46, and/or other computing devices), which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users (e.g., sending and/or receiving requests for information, etc.) may be facilitated by processor 14, server 26, mobile user device 34, desktop user device 38, and/or other components. This may occur via a website or a native application viewed on a desktop computer, tablet, or a laptop of the user. In some cases, such interaction occurs via a mobile website viewed on a smart phone, tablet, or other mobile user device, or via a special-purpose native application executing on a smart phone, tablet, or other mobile user device.

To illustrate an example of the environment in which processor 14 operates, the illustrated embodiment of FIG. 1 includes a number of components with which processor 14 communicates: mobile user device(s) 34; a desktop user device 38; and external resources 46. These devices communicate with matching processor 14 via a network 50, such as the Internet or the Internet in combination with various other networks, like local area networks, cellular networks, or personal area networks, internal organizational networks, and/or other networks.

Mobile user device(s) 34 may be smart phones, tablets, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user device(s) 34 may store instructions that when executed by the associated processor provide an operating system and various applications, including a web browser and/or a native mobile application. Desktop user device(s) 38 may also include a web browser, a native application, and/or other components. In addition, desktop user device(s) 38 may include a monitor; a keyboard; a mouse; memory; a processor; and a tangible, non-transitory, machine-readable memory storing instructions that when executed by the processor provide an operating system, the web browser, the native application, and/or other components. Native applications and web browsers, in some embodiments, are operative to provide a graphical user interface that communicates with processor 14 and facilitates user interaction with data from processor 14. Web browsers may be configured to receive a website and/or other web based communications from processor 14 having data related to instructions (for example, instructions expressed in JavaScriptTM) that when executed by the browser (which is executed by a processor) cause mobile user device 34 and/or desktop user device 38 to communicate with processor 14 and facilitate user interaction with data from processor 14. Native applications and web browsers, upon rendering a webpage and/or a graphical user interface from processor 14, may generally be referred to as client applications of processor 14 (and/or server 26, which may include processor 14), which in some embodiments may be referred to as a server. Embodiments, however, are not limited to client/server architectures, and processor 14, as illustrated, may include a variety of components other than those functioning primarily as a server.

External resources 46, in some embodiments, include sources of information such as databases, websites, etc.; external entities participating with system 10 (e.g., systems or networks that store behavior data, and/or other information); one or more servers outside of the system 10; a network (e.g., the internet); electronic storage; equipment related to Wi-Fi™ technology; equipment related to Bluetooth® technology; data entry devices; or other resources. In some embodiments, some or all of the functionality attributed herein to external resources 46 may be provided by resources included in system 10. External resources 46 may be configured to communicate with processor 14, server 26, mobile user devices 34, desktop user devices 38, and/or other components of system 10 via wired and/or wireless connections, via a network (e.g., a local area network and/or the internet), via cellular technology, via Wi-Fi technology, and/or via other resources. The number of illustrated processors 14, external resources 46, servers 26, desktop user devices 38, and mobile user devices 34 is selected for explanatory purposes only, and embodiments are not limited to the specific number of any such devices illustrated by FIG. 1, which is not to imply that other descriptions are limiting.

System 10 includes a number of components introduced above that facilitate requests for non-linear behavior predictions by users, other computing systems, and/or requests from other sources. For example, server 26 may be configured to communicate data about non-linear behavior prediction requests, results of those requests, and/or other information via a protocol, such as a representational-state-transfer (REST)-based API protocol over hypertext transfer protocol (HTTP) or other protocols. Examples of operations that may be facilitated by server 26 include requests to display, link, modify, add, or retrieve portions of non-linear behavior prediction requests and/or results of such requests, or other information. API requests may identify which data is to be displayed, linked, modified, added, or retrieved by specifying criteria for identifying records, such as queries for retrieving or processing information about a particular non-linear subject behavior prediction. In some embodiments, server 26 communicates with the native applications of mobile user device 34 and desktop user device 38, and/or other components of system 10 (e.g., e.g., to send and/or receive such requests).

Server 26 may be configured to display, link, modify, add, or retrieve portions or all data related a non-linear subject behavior prediction, results from a particular prediction, and/or other information encoded in a webpage (e.g. a collection of resources to be rendered by the browser and associated plug-ins, including execution of scripts, such as JavaScriptTM, invoked by the webpage), or in a graphical user interface display, for example. In some embodiments, a graphical user interface presented by the webpage may include inputs by which the user may enter or select data, such as clickable or touchable display regions or display regions for text input. Such inputs may prompt the browser to request additional data from server 26 or transmit data to server 26, and server 26 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScriptTM object notation (JSON) or extensible markup language (XML). Server 26 may communicate with web browsers executed by user devices 34 or 38, for example. In some embodiments, a webpage is modified by server 26 based on the type of user device, e.g., with a mobile webpage having fewer and smaller images and a narrower width being presented to the mobile user device 34, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and server 26 may select the appropriate interface based on this embedded identifier, thereby providing an interface appropriately configured for the specific user device in use.

Data store 30 stores data related to non-linear subject behavior predictions, requests, results from such requests, etc. Data store 30 may include various types of data stores, including relational or non-relational databases, document collections, hierarchical key-value pairs, or memory images, for example. Such components may be formed in a single database, document, or other component, or may be stored in separate data structures. In some embodiments, data store 30 comprises electronic storage media that electronically stores information. The electronic storage media of data store 30 may include one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Data store 30 may be (in whole or in part) a separate component within system 10, or data store 30 may be provided (in whole or in part) integrally with one or more other components of the system 10 (e.g., processors 14, etc.). In some embodiments, data store 30 may be located in a data center, in server 26, in a server that is part of external resources 46, in a computing device 34 or 38, or in other locations. Data store 30 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 30 may store software algorithms, information determined by processor 14, information received via a graphical user interface displayed on computing devices 34 and/or 38, information received from external resources 46, or other information accessed by the system 10 to function as described herein.

FIG. 7 is a diagram that illustrates an exemplary computing system 700 in accordance with embodiments of the present system. Various portions of systems and methods described herein, may include or be executed on one or more computer systems the same as or similar to computing system 700. For example, processor 14, server 26, mobile user device 34, desktop user device 38, external resources 46 and/or other components of the system 10 (FIG. 1) may be and/or include one more computer systems the same as or similar to computing system 700. Further, processes, modules, processor components, and/or other components of system 10 described herein may be executed by one or more processing systems similar to and/or the same as that of computing system 700.

Computing system 700 may include one or more processors (e.g., processors 710a-710n) coupled to system memory 720, an input/output I/O device interface 730, and a network interface 740 via an input/output (I/O) interface 750. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 700. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 720). Computing system 700 may be a uni-processor system including one processor (e.g., processor 710a), or a multi-processor system including any number of suitable processors (e.g., 710a-710n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 700 may include a plurality of computing devices (e.g., distributed computer systems) to implement various processing functions.

I/O device interface 730 may provide an interface for connection of one or more I/O devices 760 to computer system 700. I/O devices may include devices that receive input (e.g., from a user) or output information (e.g., to a user). I/O devices 760 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or other devices. I/O devices 760 may be connected to computer system 700 through a wired or wireless connection. I/O devices 760 may be connected to computer system 700 from a remote location. I/O devices 760 located on a remote computer system, for example, may be connected to computer system 700 via a network and network interface 740.

Network interface 740 may include a network adapter that provides for connection of computer system 700 to a network. Network interface may 740 may facilitate data exchange between computer system 700 and other devices connected to the network. Network interface 740 may support wired or wireless communication. The network may include an electronic communication network, such as the Internet, a local area network (LAN), a wide area network (WAN), a cellular communications network, or other networks.

System memory 720 may be configured to store program instructions 770 or data 780. Program instructions 770 may be executable by a processor (e.g., one or more of processors 710a-710n) to implement one or more embodiments of the present techniques. Instructions 770 may include modules and/or components (e.g., machine readable instructions 15 and/or components 16-20 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 720 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or other memory. System memory 720 may include a non-transitory computer readable storage medium that may have program instructions stored thereon that are executable by a computer processor (e.g., one or more of processors 710a-710n) to cause the subject matter and the functional operations described herein. A memory (e.g., system memory 720) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 750 may be configured to coordinate I/O traffic between processors 710a-710n, system memory 720, network interface 740, I/O devices 760, and/or other peripheral devices. I/O interface 750 may perform protocol, timing, or other data transformations to convert data signals from one component (e.g., system memory 720) into a format suitable for use by another component (e.g., processors 710a-710n). I/O interface 750 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 700 or multiple computer systems 700 configured to host different portions or instances of embodiments. Multiple computer systems 700 may provide for parallel or sequential processing/execution of one or more portions of the techniques described herein.

Those skilled in the art will appreciate that computer system 700 is merely illustrative and is not intended to limit the scope of the techniques described herein. Computer system 700 may include any combination of devices or software that may perform or otherwise provide for the performance of the techniques described herein. For example, computer system 700 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or other devices. Computer system 700 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

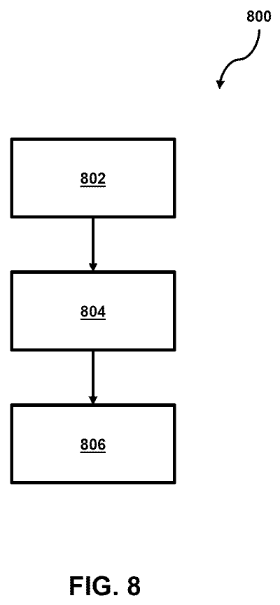

FIG. 8 illustrates a method 800 for predicting non-linear subject behavior with a prediction system. Non-linear subject behavior may include, for example, instances where the subject is a human, and the non-linear behavior comprises customer sensitivity to banking interest rate changes; customer sensitivity to provider customer service, cost, and/or quality; a customer response to advertising, media content, and/or streaming content; a drug and/or dosage sensitivity; and/or other non-linear behavior. Non-linear subject behavior may include instances where the subject is a wireless device, and the non-linear behavior comprises sensitivity to noise or alternate communication frequencies, for example. Non-linear subject behavior may include instances where the subject is a vehicle, and the non-linear behavior comprises sensitivity to human driver actions and/or physical driving environment parameters, for example. Non-linear subject behavior may include instances where the subject is a machine, and the non-linear behavior comprises location detection, temperature determination, quality determination, etc., for example. Other examples are contemplated.

The prediction system configured to execute method 800 comprises one or more processors configured by machine-readable instructions, and/or other components. The one or more processors are configured to execute computer program components. The computer program components comprise a behavior model component, a distribution component, a prediction component, and/or other components. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting.

In some embodiments, method 800 may be implemented in one or more processing devices such as one or more processors 14 described herein (FIG. 1, e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions (e.g., machine readable instructions 15) stored electronically on an electronic storage medium (e.g., data store 30). The one or more processing devices may include one or more devices configured through hardware, firmware, and/or software to be specifically designed for execution of one or more of the operations of method 800.

At an operation 802, a behavior model for a subject is determined. The behavior model describes a density of an observed behavior of a subject. The density of observed behavior comprises a quantity and/or amount of repeated statistically significant behavior over time. The density of observed behavior is determined with a mixture model derived from a Dirichlet process. In some embodiments, the behavior model is a Markov Chain Monte Carlo (MCMC) based mixture model. The behavior model is trained by comparing one or more different model outputs, generated based on known inputs, to corresponding target outputs for the known inputs, and adjusting a parameterization of the behavior model to reduce or minimize a difference between an output and a target output, for a corresponding input. In some embodiments, operation 802 is performed by a processor component the same as or similar to behavior model component 16 (shown in FIG. 1 and described herein).

At an operation 804, a prior probability subject behavior distribution associated with the observed behavior is determined. The prior probability subject behavior distribution comprises an assumption describing the observed behavior. The prior probability subject behavior distribution comprises a Gamma prior probability distribution. In some embodiments, operation 804 comprises determining parameters of the Gamma prior probability distribution by minimizing a Kullback-Leibler (KL) divergence between the Gamma prior probability distribution over a specific period or range versus a generic Gamma distribution. In some embodiments, the parameters of the Gamma prior probability distribution comprise a shape (α) and a rate (β). Advantageously, the Gamma prior probability distribution can be configured to approximate multiple distribution shapes. In some embodiments, the prior probability distribution comprises an exponential distribution, and is approximated by the Gamma prior probability distribution.

In some embodiments, as described above, the behavior model is a Markov Chain Monte Carlo (MCMC) based mixture model, and the Gamma prior probability distribution is applied as a prior in the MCMC based mixture model. In some embodiments, operation 804 is performed by a processor component the same as or similar to distribution component 18 (shown in FIG. 1 and described herein).

At an operation 806, the non-linear subject behavior is predicted. The non-linear subject behavior is predicted based on the Gamma prior probability distribution and the behavior model. In some embodiments, the predicting comprises Bayesian inferencing based on the behavior model and the Gamma prior probability distribution. In some embodiments, operation 806 comprises sampling a posterior predictive from the behavior model using a Metropolis Hastings technique. In some embodiments, operation 806 is performed by a processor component the same as or similar to prediction component 20 (shown in FIG. 1 and described herein).

In some embodiments, by way of a non-limiting example associated with operations 802-806 described above, the behavior model is a rate sensitivity behavior model. The rate sensitivity behavior model describes a customer bank account balance as a banking interest rate provided to a customer changes over time. The prior probability subject behavior distribution comprises an assumption describing customer sensitivity to the banking interest rate; and predicting the non-linear subject behavior comprises predicting non-linear customer sensitivity to the banking interest rate provided to the customer, based on the Gamma prior probability distribution and the rate sensitivity behavior model. In some embodiments, operation 806 comprises determining a banking interest rate provided to the customer based on the non-linear customer sensitivity.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and other terms, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and other similar statements (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or similar terms refer to actions or processes of a specific apparatus, such as a special purpose computer or a similar special purpose electronic processing/computing device.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

Various embodiments are disclosed in the subsequent list of numbered clauses:
1. A non-transitory computer readable medium having instructions thereon, the instructions when executed by a computer, causing the computer to predict non-linear subject behavior, the instructions causing operations comprising: determining a behavior model for the subject, the behavior model describing a density of an observed behavior of a subject; determining a prior probability subject behavior distribution associated with the observed behavior, the prior probability subject behavior distribution comprising an assumption describing the observed behavior, the prior probability subject behavior distribution comprising a Gamma prior probability distribution; predicting, based on the Gamma prior probability distribution and the behavior model, the non-linear subject behavior.
2. The medium of clause 1, wherein the operations further comprise determining parameters of the Gamma prior probability distribution by minimizing a Kullback-Leibler (KL) divergence between the Gamma prior probability distribution over a specific period or range versus a generic Gamma distribution.
3. The medium of any of the previous clauses, wherein the parameters of the Gamma prior probability distribution comprise a shape (α) and a rate (β).
4. The medium of any of the previous clauses, wherein the predicting comprises Bayesian inferencing based on the behavior model and the Gamma prior probability distribution.
5. The medium of any of the previous clauses, wherein the behavior model is a Markov Chain Monte Carlo based mixture model.
6. The medium of any of the previous clauses, wherein the density of observed behavior comprises a quantity and/or amount of repeated statistically significant behavior over time.
7. The medium of any of the previous clauses, wherein the density of observed behavior is determined with a mixture model derived from a Dirichlet process.
8. The medium of any of the previous clauses, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.
9. The medium of any of the previous clauses, wherein the Gamma prior probability distribution can be configured to approximate multiple distribution shapes, and wherein the Gamma prior probability distribution is determined by minimizing a Kullback-Leibler (KL) divergence between the Gamma prior probability distribution over a specific period or range versus a generic Gamma distribution.
10. The medium of any of the previous clauses, wherein the behavior model is a Markov Chain Monte Carlo (MCMC) based mixture model, and wherein the Gamma prior probability distribution is applied as a prior in the MCMC based mixture model.
11. The medium of any of the previous clauses, wherein the operations further comprise sampling a posterior predictive from the behavior model using a Metropolis Hastings technique.
12. The medium of any of the previous clauses, wherein the behavior model is a rate sensitivity behavior model, the rate sensitivity behavior model describing a customer bank account balance as a banking interest rate provided to a customer changes over time; wherein the prior probability subject behavior distribution comprises an assumption describing customer sensitivity to the banking interest rate; and wherein predicting the non-linear subject behavior comprises predicting non-linear customer sensitivity to the banking interest rate provided to the customer, based on the Gamma prior probability distribution and the rate sensitivity behavior model.
13. The medium of any of the previous clauses, wherein the operations further comprise determining a banking interest rate provided to the customer based on the non-linear customer sensitivity.
14. The medium of any of the previous clauses, wherein the prior probability distribution comprises an exponential distribution.
15. The medium of any of the previous clauses, wherein: the subject is a human, and wherein the observed behavior comprises customer sensitivity to banking interest rate changes; customer sensitivity to provider customer service, cost, and/or quality; a customer response to advertising, media content, and/or streaming content; or a drug and/or dosage sensitivity; the subject is a wireless device, and wherein the observed behavior comprises sensitivity to noise or alternate communication frequencies; the subject is a vehicle, and wherein the observed behavior comprises sensitivity to human driver actions and/or physical driving environment parameters; or the subject is a machine, and wherein the observed behavior comprises location detection, temperature determination, or quality determination.
16. A method for predicting non-linear subject behavior, the method comprising: determining a behavior model for the subject, the behavior model describing a density of an observed behavior of a subject; determining a prior probability subject behavior distribution associated with the observed behavior, the prior probability subject behavior distribution comprising an assumption describing the observed behavior, the prior probability subject behavior distribution comprising a Gamma prior probability distribution; predicting, based on the Gamma prior probability distribution and the behavior model, the non-linear subject behavior.
17. The method of clause 16, further comprising determining parameters of the Gamma prior probability distribution by minimizing a Kullback-Leibler (KL) divergence between the Gamma prior probability distribution over a specific period or range versus a generic Gamma distribution.
18. The method of any of the previous clauses, wherein the parameters of the Gamma prior probability distribution comprise a shape (α) and a rate (β).
19. The method of any of the previous clauses, wherein the predicting comprises Bayesian inferencing based on the behavior model and the Gamma prior probability distribution.
20. The method of any of the previous clauses, wherein the behavior model is a Markov Chain Monte Carlo based mixture model.
21. The method of any of the previous clauses, wherein the density of observed behavior comprises a quantity and/or amount of repeated statistically significant behavior over time.
22. The method of any of the previous clauses, wherein the density of observed behavior is determined with a mixture model derived from a Dirichlet process.
23. The method of any of the previous clauses, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.
24. The method of any of the previous clauses, wherein the Gamma prior probability distribution can be configured to approximate multiple distribution shapes, and wherein the Gamma prior probability distribution is determined by minimizing a Kullback-Leibler (KL) divergence between the Gamma prior probability distribution over a specific period or range versus a generic Gamma distribution.
25. The method of any of the previous clauses, wherein the behavior model is a Markov Chain Monte Carlo (MCMC) based mixture model, and wherein the Gamma prior probability distribution is applied as a prior in the MCMC based mixture model.
26. The method of any of the previous clauses, further comprising sampling a posterior predictive from the behavior model using a Metropolis Hastings technique.
27. The method of any of the previous clauses, wherein the behavior model is a rate sensitivity behavior model, the rate sensitivity behavior model describing a customer bank account balance as a banking interest rate provided to a customer changes over time; wherein the prior probability subject behavior distribution comprises an assumption describing customer sensitivity to the banking interest rate; and wherein predicting the non-linear subject behavior comprises predicting non-linear customer sensitivity to the banking interest rate provided to the customer, based on the Gamma prior probability distribution and the rate sensitivity behavior model.
28. The method of any of the previous clauses, further comprising determining a banking interest rate provided to the customer based on the non-linear customer sensitivity.
29. The method of any of the previous clauses, wherein the prior probability distribution comprises an exponential distribution.
30. The method of any of the previous clauses, wherein: the subject is a human, and wherein the observed behavior comprises customer sensitivity to banking interest rate changes; customer sensitivity to provider customer service, cost, and/or quality; a customer response to advertising, media content, and/or streaming content; or a drug and/or dosage sensitivity; the subject is a wireless device, and wherein the observed behavior comprises sensitivity to noise or alternate communication frequencies; the subject is a vehicle, and wherein the observed behavior comprises sensitivity to human driver actions and/or physical driving environment parameters; or the subject is a machine, and wherein the observed behavior comprises location detection, temperature determination, or quality determination.
31. A system for predicting non-linear subject behavior, the system comprising one or more processors configured by machine readable instructions to perform operations, the operations comprising: determining a behavior model for the subject, the behavior model describing a density of an observed behavior of a subject; determining a prior probability subject behavior distribution associated with the observed behavior, the prior probability subject behavior distribution comprising an assumption describing the observed behavior, the prior probability subject behavior distribution comprising a Gamma prior probability distribution; predicting, based on the Gamma prior probability distribution and the behavior model, the non-linear subject behavior.
32. The system of clause 31, wherein the operations further comprise determining parameters of the Gamma prior probability distribution by minimizing a Kullback-Leibler (KL) divergence between the Gamma prior probability distribution over a specific period or range versus a generic Gamma distribution.
33. The system of any of the previous clauses, wherein the parameters of the Gamma prior probability distribution comprise a shape (α) and a rate (β).
34. The system of any of the previous clauses, wherein the predicting comprises Bayesian inferencing based on the behavior model and the Gamma prior probability distribution.
35. The system of any of the previous clauses, wherein the behavior model is a Markov Chain Monte Carlo based mixture model.
36. The system of any of the previous clauses, wherein the density of observed behavior comprises a quantity and/or amount of repeated statistically significant behavior over time.
37. The system of any of the previous clauses, wherein the density of observed behavior is determined with a mixture model derived from a Dirichlet process.
38. The system of any of the previous clauses, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.
39. The system of any of the previous clauses, wherein the Gamma prior probability distribution can be configured to approximate multiple distribution shapes, and wherein the Gamma prior probability distribution is determined by minimizing a Kullback-Leibler (KL) divergence between the Gamma prior probability distribution over a specific period or range versus a generic Gamma distribution.
40. The system of any of the previous clauses, wherein the behavior model is a Markov Chain Monte Carlo (MCMC) based mixture model, and wherein the Gamma prior probability distribution is applied as a prior in the MCMC based mixture model.
41. The system of any of the previous clauses, wherein the operations further comprise sampling a posterior predictive from the behavior model using a Metropolis Hastings technique.
42. The system of any of the previous clauses, wherein the behavior model is a rate sensitivity behavior model, the rate sensitivity behavior model describing a customer bank account balance as a banking interest rate provided to a customer changes over time; wherein the prior probability subject behavior distribution comprises an assumption describing customer sensitivity to the banking interest rate; and wherein predicting the non-linear subject behavior comprises predicting non-linear customer sensitivity to the banking interest rate provided to the customer, based on the Gamma prior probability distribution and the rate sensitivity behavior model.
43. The system of any of the previous clauses, wherein the operations further comprise determining a banking interest rate provided to the customer based on the non-linear customer sensitivity.
44. The system of any of the previous clauses, wherein the prior probability distribution comprises an exponential distribution.
45. The system of any of the previous clauses, wherein: the subject is a human, and wherein the observed behavior comprises customer sensitivity to banking interest rate changes; customer sensitivity to provider customer service, cost, and/or quality; a customer response to advertising, media content, and/or streaming content; or a drug and/or dosage sensitivity; the subject is a wireless device, and wherein the observed behavior comprises sensitivity to noise or alternate communication frequencies; the subject is a vehicle, and wherein the observed behavior comprises sensitivity to human driver actions and/or physical driving environment parameters; or the subject is a machine, and wherein the observed behavior comprises location detection, temperature determination, or quality determination.
46. A non-transitory computer readable medium having instructions thereon, the instructions, when executed by a computer, causing the computer to predict non-linear customer sensitivity to a banking interest rate provided to the customer, the predicting based on a Gamma prior probability customer behavior distribution instead of a normal prior probability customer behavior distribution, the predicting configured to enhance a determination of the banking interest rate provided to the customer compared to a banking interest rate that would otherwise have been provided, the instructions causing operations comprising: determining a rate sensitivity behavior model, the rate sensitivity behavior model describing a customer bank account balance as the banking interest rate provided to the customer changes over time, wherein the rate sensitivity behavior model is a Markov Chain Monte Carlo based mixture model; determining a prior probability customer behavior distribution associated with customer sensitivity to the banking interest rate, the prior probability customer behavior distribution comprising an assumption describing customer sensitivity to the banking interest rate, the prior probability customer behavior distribution comprising the Gamma prior probability customer behavior distribution; predicting, based on the Gamma prior probability customer behavior distribution and the rate sensitivity behavior model, the non-linear customer sensitivity to the banking interest rate provided to the customer; and determining the banking interest rate provided to the customer based on the non-linear customer sensitivity.
47. The medium of any of the previous clauses, wherein the operations further comprise determining parameters of the Gamma prior probability customer behavior distribution by minimizing a Kullback-Leibler (KL) divergence between the Gamma prior probability customer behavior distribution over a specific period or range versus a generic Gamma distribution.
48. The medium of any of the previous clauses, wherein the parameters of the Gamma prior probability customer behavior distribution comprise a shape (α) and a rate (β).
49. The medium of any of the previous clauses, wherein the predicting comprises Bayesian inferencing based on the rate sensitivity behavior model and the Gamma prior probability customer behavior distribution.
50. The medium of any of the previous clauses, wherein rate sensitivity comprises changes in bank account balance with respect to interest rate over time.
51. A non-transitory computer readable medium having instructions thereon, the instructions, when executed by a computer, causing the computer to predict non-linear subject behavior in response to stimulus content, the predicting based on a Gamma prior probability behavior distribution instead of a normal prior probability behavior distribution, the predicting configured to enhance a determination of future content stimuli compared to content stimuli that would otherwise have been determined for a subject, the instructions causing operations comprising: determining a behavior model for the subject, wherein: the behavior model describes a density of an observed behavior of the subject, the behavior model is a Markov Chain Monte Carlo based mixture model, and the density is determined with a mixture model derived from a Dirichlet process; determining a prior probability subject behavior distribution associated with the observed behavior, wherein: the prior probability subject behavior distribution comprises a Gamma prior probability distribution, parameters of the Gamma prior probability distribution comprise a shape (α) and a rate (β), and parameters of the Gamma prior probability distribution are determined by minimizing a Kullback-Leibler (KL) divergence between the Gamma prior probability distribution over a specific period or range versus a generic Gamma distribution; receiving the stimulus content; predicting, based on the stimulus content, the Gamma prior probability behavior distribution, and the behavior model, the non-linear subject behavior; and determining the future content stimuli based on the non-linear subject behavior.
52. The medium of any of the previous clauses, wherein the predicting comprises Bayesian inferencing based on the behavior model and the Gamma prior probability distribution.
53. The medium of any of the previous clauses, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.
54. The medium of any of the previous clauses, wherein the density of observed behavior comprises a quantity and/or amount of repeated statistically significant behavior over time.
55. The medium of any of the previous clauses, wherein: the subject is a human, and wherein the observed behavior comprises customer sensitivity to first stimulus content comprising banking interest rate changes, provider customer service, provider cost, provider quality, advertising, media content, streaming content, or a drug and/or dosage of the drug; the subject is a wireless device, and wherein the observed behavior comprises sensitivity to second stimulus content comprising noise or alternate communication frequencies; the subject is a vehicle, and wherein the observed behavior comprises sensitivity to third stimulus content comprising human driver actions and/or a physical driving environment; or the subject is a machine, and wherein the observed behavior comprises location detection, temperature determination, or quality determination responsive to fourth stimulus content comprising normal operation of the machine.

What is claimed is:

1. A non-transitory computer readable medium having instructions thereon, the instructions, when executed by a computer, causing the computer to predict non-linear subject behavior in response to stimulus content, the predicting based on a Gamma prior probability behavior distribution instead of a normal prior probability behavior distribution, the predicting configured to enhance a determination of future content stimuli compared to content stimuli that would otherwise have been determined for a subject, the instructions causing operations comprising:
determining a behavior model for the subject, wherein:
the behavior model describes a density of an observed behavior of the subject,
the behavior model is a Markov Chain Monte Carlo based mixture model, and
the density is determined with a mixture model derived from a Dirichlet process;
determining a prior probability subject behavior distribution associated with the observed behavior, wherein:
the prior probability subject behavior distribution comprises a Gamma prior probability distribution,
parameters of the Gamma prior probability distribution comprise a shape (α) and a rate (β), and
parameters of the Gamma prior probability distribution are determined by minimizing a Kullback-Leibler (KL) divergence between the Gamma prior probability distribution over a specific period or range versus a generic Gamma distribution;
receiving the stimulus content;
predicting, based on the stimulus content, the Gamma prior probability behavior distribution, and the behavior model, the non-linear subject behavior; and
determining the future content stimuli based on the non-linear subject behavior.

2. The medium of claim 1, wherein the predicting comprises Bayesian inferencing based on the behavior model and the Gamma prior probability distribution.

3. The medium of claim 1, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.

4. The medium of claim 1, wherein the density of observed behavior comprises a quantity and/or amount of repeated statistically significant behavior over time.

5. The medium of claim 1, wherein:
the subject is a human, and wherein the observed behavior comprises customer sensitivity to first stimulus content comprising banking interest rate changes, provider customer service, provider cost, provider quality, advertising, media content, streaming content, or a drug and/or dosage of the drug;
the subject is a wireless device, and wherein the observed behavior comprises sensitivity to second stimulus content comprising noise or alternate communication frequencies;
the subject is a vehicle, and wherein the observed behavior comprises sensitivity to third stimulus content comprising human driver actions and/or a physical driving environment; or
the subject is a machine, and wherein the observed behavior comprises location detection, temperature determination, or quality determination responsive to fourth stimulus content comprising normal operation of the machine.

6. A non-transitory computer readable medium having instructions thereon, the instructions when executed by a computer, causing the computer to predict non-linear subject behavior that occurs in response to stimulus content, the instructions causing operations comprising:
determining a behavior model for the subject, the behavior model describing a density of an observed behavior of a subject;
determining a prior probability subject behavior distribution associated with the observed behavior, the prior probability subject behavior distribution comprising an assumption describing the observed behavior, the prior probability subject behavior distribution comprising a Gamma prior probability distribution;
receiving the stimulus content; and
predicting, based on the stimulus content, the Gamma prior probability distribution, and the behavior model, the non-linear subject behavior.

7. The medium of claim 6, wherein the operations further comprise determining parameters of the Gamma prior probability distribution by minimizing a Kullback-Leibler (KL) divergence between the Gamma prior probability distribution over a specific period or range versus a generic Gamma distribution.

8. The medium of claim 7, wherein the parameters of the Gamma prior probability distribution comprise a shape (α) and a rate (β).

9. The medium of claim 6, wherein the predicting comprises Bayesian inferencing based on the behavior model and the Gamma prior probability distribution.

10. The medium of claim 6, wherein the behavior model is a Markov Chain Monte Carlo based mixture model.

11. The medium of claim 6, wherein the density of observed behavior comprises a quantity and/or amount of repeated statistically significant behavior over time.

12. The medium of claim 11, wherein the density of observed behavior is determined with a mixture model derived from a Dirichlet process.

13. The medium of claim 6, wherein the behavior model is trained by comparing one or more different model outputs, generated based on known inputs, to corresponding target outputs for the known inputs, and adjusting a parameterization of the behavior model to reduce or minimize a difference between an output and a target output, for a corresponding input.

14. The medium of claim 6, wherein the Gamma prior probability distribution can be configured to approximate multiple distribution shapes, and wherein the Gamma prior probability distribution is determined by minimizing a Kullback-Leibler (KL) divergence between the Gamma prior probability distribution over a specific period or range versus a generic Gamma distribution.

15. The medium of claim 6, wherein the behavior model is a Markov Chain Monte Carlo (MCMC) based mixture model, and wherein the Gamma prior probability distribution is applied as a prior in the MCMC based mixture model.

16. The medium of claim 6, wherein the operations further comprise sampling a posterior predictive from the behavior model using a Metropolis Hastings technique.

17. The medium of claim 7, wherein the behavior model is a rate sensitivity behavior model, the rate sensitivity behavior model describing a customer bank account balance as a banking interest rate provided to a customer changes over time;
wherein the prior probability subject behavior distribution comprises an assumption describing customer sensitivity to the banking interest rate; and
wherein predicting the non-linear subject behavior comprises predicting non-linear customer sensitivity to the banking interest rate provided to the customer, based on the Gamma prior probability distribution and the rate sensitivity behavior model.

18. The medium of claim 17, wherein the operations further comprise determining a banking interest rate provided to the customer based on the non-linear customer sensitivity.

19. The medium of claim 6, wherein the prior probability distribution comprises an exponential distribution.

20. The medium of claim 6, wherein:
the subject is a human, and wherein the observed behavior comprises customer sensitivity to banking interest rate changes; customer sensitivity to provider customer service, cost, and/or quality; a customer response to advertising, media content, and/or streaming content; or a drug and/or dosage sensitivity;
the subject is a wireless device, and wherein the observed behavior comprises sensitivity to noise or alternate communication frequencies;
the subject is a vehicle, and wherein the observed behavior comprises sensitivity to human driver actions and/or physical driving environment parameters; or
the subject is a machine, and wherein the observed behavior comprises location detection, temperature determination, or quality determination.
